(19) United States
(12) Patent Application Publication
(10) Pub. No.: US 2005/0018175 A1
(43) Pub. Date: Jan. 27, 2005

(54) Method for deriving a calibration and method for image processing

(76) Inventor: Tzu-Hung Cheng, Taiwan (CN)

Correspondence Address: U S Philips Corporation;Intellectual Property Department, P O Box 3001, Briarcliff Manor, NY, 10510, US

(21) Appl. No.: 10/494,827

(22) PCT Filed: Oct. 24, 2002
(86) PCT No.: PCT/IB02/04453

(30) Foreign Application Priority Data
Nov. 13, 2001 (EP) 01204333.7

(51) Int. Cl. G01B 9/00

(52) U.S. Cl. 356/124

(57) ABSTRACT

An approximation method for deriving the first coefficient of radial aberration model is proposed. This invention idea enables a digital camera system to automatically find a good parameter in order to correct radial lens distortion by capturing an image with a single straight line. The proposed method is computationally efficient for a digital camera to perform radial lens correction in real time.

The invention regards a method for deriving a calibration comprising at least one calibration parameter, of an optical system having aberration, wherein due to the aberration, a straight line in a reference image is reproduced to a curved line in a reproduced reference image and to provide the at least one calibration parameter, the deviation between the straight line and the curved line is used in a computation. Further the invention regards a method for image processing wherein an optical system having aberration is calibrated by means of a calibration derived from the reproduction of a reference image wherein due to the aberration, a straight line in a reference image is reproduced to a curved line in a reproduced reference image and to provide the at least one calibration parameter the deviation between the straight line and the curved line is used in a computation.

Conventionally, the finding of correspondences between the input image and a reference image for deriving aberration parameters by minimizing a cost function may be required. One other approach computes the tri-linear tensor of several different projected images. Such approaches require explicit knowledge of a reference image or many input images for self-reference.

Imperfections in a camera optics often create aberration present in the acquired images. Besides spheric and chromatic aberration, astigmatism, coma, distortion and curvature of the image plain may be comprised by such aberration. This may result specifically in a barrel of pincushion like aberration in an acquired image referred to as radial aberration. The radial aberration is quite apparent for those low prize cameras equipped with inexpensive lenses. This problem is of concern for digital imaging system manufacturers and in particular for makers of digital cameras and key component suppliers. The solution to this problem is typically the integration of an expensive optical system as proposed in the Japanese patent application JP-A-11-313250. Further an alternative solution is to digitally correct such radial aberration as described in the Japanese patent application JP-A-10-187929.

In the article “Line based correction of radial lens distortion” by B. Prescot and G. F. McLean in “Graphical Models and Image Processing”, Vol. 59, No. 1, January 1997, pages 39-47, Article No. IP960407, it is proposed to optimize distortion parameters for such correction on a basis of a reproduction of a plurality of straight lines to curved lines assigned to a particular line support region elected on the joint criteria of similarity of local gradient orientation and a special connectedness. A set of equations based on a set of line equations and a set of equations accounting for the deviation between the set of straight lines and the set of curved lines is entirely solved to compute the parameters of a global forward mapping from a distorted image to a corrected image. Such global computation to achieve integral solutions demands for sufficient computational effort and is not suitable for real time applications.

This is where the invention comes in, the object of which is to specify a method for deriving a calibration and a method for image processing which are capable for real-time and semi-automatically calibration of an optical system. Further a suitable image system should be provide. In particular a camera may comprise such optical system and also an imager containing an array of discrete element for sampling the image provided by the optical system, such as charge transfer devices, in particular CCD or CED sensors e.g. based on a CMOS technology.

The object is solved by a method for deriving a calibration as mentioned in the introductory wherein in accordance with the invention it is proposed, that for the computation a geometry-relationship of discrete points on the straight line is provided, an approximation-relationship accounting for the deviation between discrete points on the straight line and respective points on the curved line containing the at least one calibration parameter is provided and the at least one calibration parameter is derived from the geometry-relationship and the approximation-relationship and the calibration is derived based on a single straight line close to the border of the reference image.

Further the invention leads to a method for image processing as mentioned in the introductory by which the object is solved and wherein according to the invention it is proposed that for the computation a geometry relationship of discrete points on the straight line is provided, an approximation-relationship accounting for the deviation between discrete points on the straight line and respective points on the curved line, containing the at least one calibration parameter is provided, the at least one calibration parameter is derived from the geometric-relationship and the approximation-relationship, wherein the calibration is derived based on a single straight line close to the boarder of the reference image and the image is reproduced by the optical system and further processed and wherein a distortion of the reproduced image resulting from the aberration of the optical system is corrected by use of the calibration.

Such correction based on a method for deriving a calibration and comprised by a method for image processing as proposed, may be done in real time for video capturing with hardware acceleration or offline for single image capturing. It was realized, that especially for low cost applications it is sufficient to provide a geometry relationship and an approximation relationship on the basis of discrete points on a single straight line and a single curved line for derivation of at least one calibration parameter for a real-time application and semi-automatical calibration of an optical system. The main concept proposed is therefore to derive the calibration based on a single straight line close to the border of the reference image and thereby advantageously derive one calibration parameter. According to the concept such measures are sufficient to digitally correct an aberration of an optical system.

The advantages may even be improved by continued developed configurations as described in the dependent claims.

In particular it is preferred that the geometry-relationship is applied for three points on the single straight line. In a preferred configuration one of the points is located in a left section of the single straight line, one of the points is located in a middle section of the single straight line and one of the points is located in a right section of the single straight line. Such optimized spreading of the points on the single straight line guarantees reliable and efficient over-all-compensation of the aberration throughout an image.

Preferably the approximation-relationship is based on one single calibration parameter, which is most efficient for a real-time-requirement.

In a preferred configuration, the single straight line extends in an outer frame of the reference image, wherein the outer frame may overcast up to 50% of the surface of the reference image. Specifically, the single straight line extends in the reference image at a distance from the border of the reference image which amounts to not more than 30% of a diameter of the reference image.

In a further preferred configuration advantageously the single straight line is a horizontal line. It also may be a vertical line. A horizontal line is capable to compensate an aberration of a rectangular image with a width greater than its height.

Advantageously, the calibration parameter is derived by iteration of the geometry and the approximation relationship. An iteration may give a very quick result as soon a required precision of the result may be lowered. Such compromise may be adjusted advantageously.

In a further preferred configuration from the reference image a binary reference image is derived to be used as the reference image. Advantageously the single straight line is derived from the reference image by thinning, in particular by thinning to one pixel width. Thereby any image may serve as a reference image. A straight line is extracted in an efficient way.

Further the invention leads to an image system comprising a device adapted to implement a method as proposed.

Such image system may comprise also an optical system and an image sensor, such as CMOS, CCD or CED imagers. The device may be a processor device for deriving a video output from an image signal comprising a memory and a processing unit. Also an interface, in particular an interface connectable to an image sensor and an interface connectable to a monitor, may be provided.

The invention will now be described with reference to the accompanying drawing.

While there has been shown and described what is considered to be a preferred embodiment of the invention, it will of course be understood that various modifications and changes in form or detail could readily be made without departing from the spirit of the invention. It is therefore intended that the invention may not be limited to the exact form and detail herein shown and described nor to anything less than the whole of the invention herein disclosed as herein after claimed. The detailed description of the preferred embodiment is illustrated in the Figures of the drawing in which:

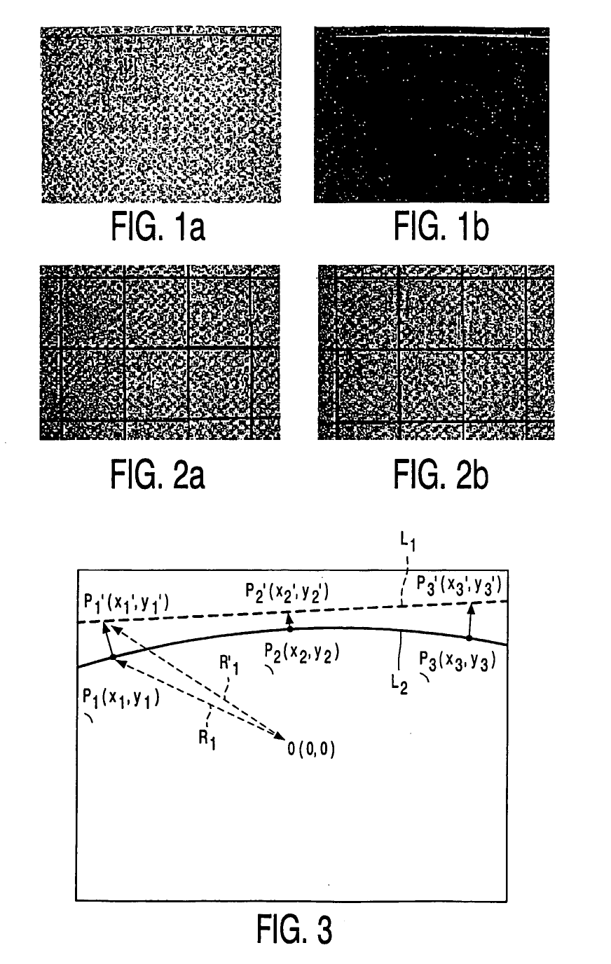

FIG. 1a shows a horizontal line image;

FIG. 1b shows a binary image after thinning process;

FIG. 2a shows an original image;

FIG. 2b shows a corrected image;

FIG. 3 illustrates the method of a preferred embodiment with a set of extracted discrete pixels on a curved line and corresponding correct positions.

The radial aberration is modelled as a function of distance from the pixel to the image center O in FIG. 3. Equation 1 is the aberration model and R is the distance from the distorted pixel to the center O of the image. As mentioned a one parameter model is sufficient for most inexpensive lenses. The simplified model represented in Euclidean coordinates is described as in equation 2.
R=R′(1+γ₁R^{′2}+γ₂R^{′4}+γ₃R^{′6}+ . . . ) (1)
x=x′+γ₁(x′−Cₓ)R^{′2}
y=y′+γ₁(y′−C_{y})R^{′2} (2)

Where R^{′2}=(x′−Cₓ)²+(y′−C_{y})² and the pixel p(x, y) correspond to the distorted pixel, p(x′, y′) to the corrected pixel, and (Cₓ, C_{y}) to the optical center of the image respectively. For a low cost camera lens the optics manufactures typically do not provide the factory aberration parameters, γₛ. Therefore, the digital camera makers often do nothing to the aberration correction, which leads to inaccurate results.

The preferred embodiment of the method proposes a semi-automated way to derive γ₁. The derived γ₁ will help to develop a look-up-table for lens correction that can be performed in real-time with hardware acceleration. This allows users to self-calibrate the upgraded lenses or digital camera makers to use inexpensive lenses for high quality cameras.

The proposed method gives a robust and computationally efficient way to derive the first aberration parameter g₁. One input image with a single straight line is sufficient for this task. The simplicity of this technique makes it suitable for application in consumer appliance.

The aberration model is described in equation (2) and is applied for backward mapping of distortion correction. When shifting the origin to the image optical center and moving x′ to the other side, equation (2) is simplified as (3).

$$\begin{matrix}{x}^{′} = \frac{x}{1 + {γ}_{1} {R}^{′2}} \\ {y}^{′} = \frac{y}{1 + {γ}_{1} {R}^{′2}}\end{matrix} \qquad ( 3 )$$

On the constraint that |γR^{′2}|<<1, x′ and y′ approach to x and y that leads to R^{′2}=R². x′ and y′ are approximated as

$$\begin{matrix}{x}^{′} = \frac{x}{1 + {γ}_{1} ( {x}^{2} + {y}^{2} )} \\ {y}^{′} = \frac{y}{1 + {γ}_{1} ( {x}^{2} + {y}^{2} )}\end{matrix} \qquad ( 4 )$$

It is assumed that P₁′(x₁′, y₁′), P₂′(x₂′, y₂′), and P₃′(x₃′, y₃′) as indicated in FIG. 3 are three pixels on the undistorted image and are located on a straight line L₁ of FIG. 3. This is referred to as tri-linear). That means P₁′, P₂′, and P₃′ are tri-linear in real world and shown as points on a curvature L₂ in the acquired image. This phenomenon is caused by radial distortion).

In geometry, the relationships of tri-linear pixels are represented as below.

$$\frac{{x}_{1}^{′} - {x}_{s}^{′}}{{y}_{1}^{′} - {y}_{2}^{′}} = \frac{{x}_{1}^{′} - {x}_{3}^{′}}{{y}_{1}^{′} - {y}_{3}^{′}} \qquad ( 5 )$$

By substituting equation (4) into equation (5), we have

$$\frac{{x}_{1} - {x}_{2} + {γ}_{1} ( {x}_{1} {R}_{2}^{2} - {x}_{2} {R}_{1}^{2} )}{{y}_{1} - {y}_{2} + {γ}_{1} ( {y}_{1} {R}_{2}^{2} - {y}_{2} {R}_{1}^{2} )} = \frac{{x}_{2} - {x}_{3} + {γ}_{1} ( {x}_{1} {R}_{3}^{2} - {x}_{3} {R}_{1}^{2} )}{{y}_{1} - {y}_{3} + {γ}_{1} ( {y}_{1} {R}_{3}^{2} - {x}_{3} {R}_{1}^{2} )} \qquad ( 6 )$$

This can be simplified as

$$\frac{a + {γ}_{1} b}{c + {γ}_{1} d} = \frac{e + {γ}_{1} f}{g + {γ}_{1} h}$$

where a=x₁−x₂, b=x₁R₂²−x₂R₁^{2,} and vice versa. By restructuring above equation, one obtains
F(γ₁)=(df−bh)γ₁²+(de+cf−ah−gb)γ₁+(ce−ag)=0 (7)

The solution of γ₁ is selected as with minimum absolute value.

Since γ₁ is an approximation resulting from equations (4) and (5), γ₁ is substituted into equation (4) for deriving an approximation of R′². The R′² is further substituted into equations (3) and (5) for a more accurate γ₁. After a few iterations, the computation for γ₁ is ceased when the change of γ₁ is less than a threshold, e.g. 10⁻⁵.

The procedure is listed in detail as below.
1. Input an image with a horizontal line close to image border like in FIG. 1a.
2. Reduce the color depth of the input image into single bit, e.g. derive binary image from the input image.
3. Thinning (morphological operation) the horizontal line of the binary image to one pixel width as illustrated in FIG. 1b.
4. Extract three pixels (trilinear) P′₁, P′₂ and P′₃ from the line L₁ as in FIG. 3. Make sure pixels are located on the left, middle, and right section of the line.
5. Solve γ₁ from equations (4) and (5) with minimum absolute value.
6. Substitute γ₁ into equation (4) for deriving R′² and apply it to equations (3) and (5) for iterative solving γ₁.
7. Iteratively repeat step 6 until the change of γ₁ is less than a threshold, e.g. 10⁻⁵.

FIGS. 2a and 2b demonstrate an original image and a corrected image respectively by employing the γ₁ obtained from the proposed approach.

FIG. 3 illustrates the relationship of an extracted pixel set and the corresponding undistorted positions.

1. Method for deriving a calibration comprising at least one calibration parameter, of an optical system having aberration, wherein
due to the aberration, a straight line (L₁) in a reference image is reproduced to a curved line (L₂) in a reproduced reference image and
to provide the at least one calibration parameter the deviation between the straight line (L₁) and the curved line (L₂) is used in a computation,
characterized in that
for the computation, a geometry-relationship (5) of discrete points (P₁′, P₂′, P₃′) on the straight line is provided,
an approximation-relationship (4) accounting for the deviation between the discrete points on the straight line and respective discrete points (P₁, P₂, P₃) on the curved line, containing the at least one calibration parameter (γ₁) is provided,
the at least one calibration parameter (γ₁) is derived from the geometry-relationship (5) and the approximation-relationship (4), and
wherein the calibration is derived based on a single straight line (L₁) close to the border of the reference image.

2. Method as claimed in claim 1, characterized in that the geometry-relationship (5) is applied for three points (P′₁, P′₂, P′₃) on the single straight line (L₁).

3. Method as claimed claim 1, characterized in that one of the points (P′₁) is located in a left section of the single straight line (L₁), one of points (P′₂) is located in a middle section of the single straight line (L₁) and one of the points (P′₃) is located in a right section of the single straight line (L₁).

4. Method as claimed in claim 1, characterized in that the approximation-relationship (4) is based on one single calibration parameter (γ₁).

5. Method as claimed in claim 1, characterized in that the single straight line (L₁) extends in an outer frame of the reference image, wherein the outer frame may overcast up to 50% of the surface of the reference image.

6. Method as claimed in claim 1, characterized in that the single straight line (L₁) extends in the reference image at a distance from the border of the reference image which is not more than 30% of a diameter of the reference image.

7. Method as claimed in claim 1, characterized in that the single straight line (L₁) is a horizontal line.

8. Method as claimed in claim 1, characterized in that the calibration parameter (γ₁) is derived by iteration of the geometry- (5) and the approximation-relationship (4).

9. Method as claimed in claim 1, characterized in that from the reference image a binary reference image is derived to be used as the reference image.

10. Method as claimed in claim 1, characterized in that the single straight line (L₁) is derived from the reference image by thinning, in particular by thinning to a one pixel width.

11. Method for image processing wherein an optical system having aberration is calibrated by means of a calibration derived from the reproduction of a reference image wherein
due to the aberration, a straight line (L₁) in a reference image is reproduced to a curved line (L₂) in a reproduced reference image and
to provide the at least one calibration parameter the deviation between the straight line and the curved line is used in a computation,
characterized in that
for a computation a geometry-relationship (5) of discrete points (P′₁, P′₂, P′₃) on the straight line (L₁) is provided,
an approximation-relationship (4) accounting for the deviation between discrete points (P′₁, P′₂, P′₃) on the straight line (L₁) and respective points (P₁, P₂, P₃) on the curved line (L₂), containing the at least one calibration parameter (γ₁) is provided,
that at least one calibration parameter (γ₁) is derived from the geometry-relationship (5) and the approximation-relationship (4), and
wherein the calibration is derived based on a single straight line (L₁) close to the border of the reference image and the image is reproduced by the optical system and further processed, and wherein a distortion of the reproduced image resulting from the aberration of the optical system is corrected by use of the calibration.

12. Image system comprising a device adapted to implement a method as claimed in claim 1.
